(19) United States
(12) Patent Application Publication
(10) Pub. No.: US 2010/0101719 A1
(43) Pub. Date: Apr. 29, 2010

(54) OPTICAL ELEMENT AND METHOD FOR PRODUCING SAME

(75) Inventors: Kenji OTSUKA, Suwa (JP); Yasuhide MATSUO, Matsumoto (JP); Takenori SAWAI, Fujimi (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/578,098

(22) Filed: Oct. 13, 2009

(30) Foreign Application Priority Data
Oct. 28, 2008 (JP) 2008-277466

(51) Int. Cl. B32B 38/00

(52) U.S. Cl. 156/272.6

(57) ABSTRACT

An optical element includes a first optical component and a second optical component each having light transmission properties; and a bonding film bonding together the first and the second optical components. The bonding film is formed by plasma polymerization and includes an Si skeleton having a random atomic structure including a siloxane (Si—O) bond and leaving groups binding to the Si skeleton. The first and the second optical components are bonded together by the bonding film having adhesive properties provided by applying energy to at least a part of the bonding film to eliminate the leaving groups from the Si skeleton at a surface of the bonding film. Additionally, the bonding film is formed so as to have approximately the same refractive index as that of at least one of the first and the second optical components by adjusting a film forming condition of the plasma polymerization.

The entire disclosure of Japanese Patent Application No. 2008-277466, filed Oct. 28, 2008 is expressly incorporated by reference herein.

### BACKGROUND

1. Technical Field

The present invention relates to an optical element and a method for producing the optical element.

2. Related Art

Conventionally, two members (substrates) are bonded (adhesively bonded) together by an adhesive such as an epoxy, urethane, or silicone.

The adhesives can exhibit adhesion properties regardless of the material of the members to be bonded together and thus can achieve bonding between various combinations of members made of different materials.

For example, a wavelength plate is an optical element providing a phase difference to light transmitted therethrough. The wavelength plate is formed by combining two sheets of substrates made of birefringent crystal such as quartz crystal. The substrates are bonded together by an adhesive.

When bonding together the substrates by an adhesive as above, a liquid or paste adhesive is applied on a bonded surface of at least one of the substrates to bond the substrates to each other via the applied adhesive. Then, heat or light is applied to cure the adhesive, thereby bonding the substrates together.

Meanwhile, the light transmittance of the wavelength plate is influenced by a refractive index difference between the adhesive and the substrates. Thus, to increase the light transmittance, it is desirable to reduce the refractive index difference. However, in general, the refractive index of an adhesive tends to be uniquely determined in accordance with a composition of the adhesive, so that it is difficult of adjust the refractive index to an arbitrary value.

Accordingly, for example, JP-A-1995-188638 discloses an adhesive composition that contains a refractive index adjuster for adjusting the refractive index of an adhesive in accordance with a refractive index of substrates. The refractive index adjuster-containing adhesive composition includes a urethane hot melt adhesive as its main component and an aromatic organophosphorus compound as an additive. As such, the refractive index of the refractive index adjuster-containing adhesive composition can be adjusted by changing an amount of the additive to be added.

Usually, however, such an additive is added during production of the adhesive and thus, the refractive index of the adhesive cannot be adjusted after production. Consequently, in accordance with the refractive index of substrates to be bonded together, it is necessary to prepare many kinds of adhesives having different refractive indexes. This is extremely inefficient for industrial use.

Additionally, it is difficult to apply the adhesive evenly at a predetermined thickness, inevitably causing a distance variation between the substrates. In this case, various kinds of aberrations including a wave surface aberration occur on the wavelength plate, so that the optical performance of the wavelength plate may be reduced.

Furthermore, the adhesive used is made of a resin material and thus is less resistant to light-induced damage which can cause a change in the refractive index over time. This is another concern in bonding optical components.

### SUMMARY

An optical element is provided that includes a bonding film provided between two optical components and has approximately the same refractive index as that of at least one of the optical components and that exhibits high light induced damage resistance and high light transmission properties obtained by strongly bonding together the optical components with high size precision via the bonding film. A method for readily producing the optical element is also provided.

The above is achieved by following aspects.

An optical element according to a first aspect includes a first optical component and a second optical component each having light transmission properties; and a bonding film bonding together the first and the second optical components, the bonding film being formed by plasma polymerization and including an Si skeleton having a random atomic structure including a siloxane (Si—O) bond and leaving groups binding to the Si skeleton, the first and the second optical components being bonded together by the bonding film having adhesive properties provided by applying energy to at least a part of the bonding film to eliminate the leaving groups from the Si skeleton at a surface of the bonding film; and the bonding film being formed so as to have approximately the same refractive index as a refractive index of at least one of the first and the second optical components by adjusting a film forming condition in the plasma polymerization.

Thereby, there can be obtained an optical element that has approximately the same refractive index as that of at least one of the optical components to be bonded together and that exhibits high light induced damage resistance and high light transmission properties by strongly bonding together the two optical components with high precision.

Preferably, in the optical element of the aspect, in all atoms except for H atoms included in the bonding film, a sum of a content of Si atoms and a content of O atoms ranges from 10 to 90 atom percent.

Thereby, in the bonding film, the Si atoms and the O atoms form a strong network, so that the bonding film in itself can be made strong. In addition, the bonding film thus formed exhibits particularly high bonding strength against the first and the second optical components.

Preferably, in the optical element of the aspect, a ratio of the Si atoms and the O atoms in the bonding film ranges from 3:7 to 7:3.

Thereby, stability of the bonding film can be increased, so that the first and the second optical components can be more strongly bonded together.

Preferably, in the optical element of the aspect, a degree of crystallization of the Si skeleton is equal to or less than 45 percent.

Thereby, the Si skeleton can include a particularly random atomic structure, whereby the bonding film obtained can have high size precision and high adhesion properties.

Preferably, in the optical element of the aspect, the bonding film includes an Si—H bond.

The Si—H bond seems to inhibit regular generation of the siloxane bond, so that the siloxane bond is formed in a manner avoiding the Si—H bond, thus reducing a structural regularity of the Si-skeleton. Accordingly, in the plasma polymerization, since the Si—H bond is included in the bonding film, the Si skeleton having a low degree of crystallization can be efficiently formed.

Preferably, in the optical element, when a peak intensity of the siloxane bond is set to 1 in an infrared absorption spectrum of the bonding film including the Si—H bond, a peak intensity of the Si—H bond ranges from 0.001 to 0.2.

Thereby, the atomic structure in the bonding film becomes relatively the most random. Accordingly, the bonding film becomes particularly excellent in bonding strength, chemical resistance, and size precision.

Preferably, in the optical element of the aspect, the leaving groups include at least one of an H atom, a B atom, a C atom, an N atom, an O atom, a P atom, an S atom, a halogen atom, and an atom group in which each of the atoms is arranged so as to bind to the Si skeleton.

The leaving groups including at least one of these is relatively excellent in selectivity of binding/leaving by application of energy and thus can be relatively easily and evenly eliminated by application of energy, thereby further improving adhesion properties of the bonding film.

Preferably, in the optical element, the leaving groups are alkyl groups.

Thereby, the bonding film obtained is excellent in environmental resistance and chemical resistance.

Preferably, in the optical element, when a peak intensity of the siloxane bond is set to 1 in the infrared absorption spectrum of the bonding film including methyl groups as the leaving groups, a peak intensity of the methyl group ranges from 0.05 to 0.45.

Thereby, a content of the methyl groups can be set as desired. This prevents the methyl group from inhibiting generation of the siloxane bond more than necessary, while allowing generation of a desired and sufficient number of active bonds in the bonding film. As a result, the bonding film becomes sufficiently adhesive. In addition, the bonding film obtains sufficient environmental resistance and chemical resistance attributed to the methyl group.

Preferably, in the optical element of the aspect, the bonding film includes an active bond at a portion where the leaving groups present at least around the surface of the bonding film are eliminated from the Si skeleton.

Thereby, the bonding film can be strongly bonded to the second optical component based on chemical bonding.

Preferably, in the optical element, the active bond is a dangling bond or a hydroxyl group.

Thereby, the bonding film can be particularly strongly bonded to the second optical component.

Preferably, in the optical element of the aspect, the bonding film is mainly made of polyorganosiloxane.

Thereby, the bonding film obtained exhibits higher adhesion properties. In addition, the bonding film has high environmental resistance and high chemical resistance. Thus, for example, the bonding film may be useful in bonding between optical components that will be exposed to a chemical agent or the like over a long period of time.

Preferably, in the optical element, the polyorganosiloxane predominantly contains a polymer of octamethyltrisiloxane.

Thereby, the bonding film obtained exhibits particularly excellent adhesion properties.

Preferably, in the optical element of the aspect, in the plasma polymerization, a high frequency output density for generating plasma is adjusted in a range from 0.01 to 100 W/cm².

Thereby, it can be prevented that plasma energy is excessively applied to raw gas due to an excessively high frequency output density, as well as it can be ensured that the Si skeleton having the random atomic structure is formed. Additionally, the bonding film can be formed while surely adjusting the refractive index to an intended value.

Preferably, in the optical element of the aspect, a mean thickness of the bonding film ranges from 1 to 1,000 nm.

This can prevent extreme reduction in the size precision of the optical element formed by bonding together the first and the second optical components, as well as can increase bonding strength between the optical components.

Preferably, in the optical element of the aspect, the bonding film is a solid having no fluidity.

Thereby, the size precision of the optical element obtained can be particularly higher than in conventional optical elements. Additionally, as compared to the conventional ones, strong bonding between the optical components can be achieved in a short time.

Preferably, in the optical element of the aspect, the refractive index of the bonding film is adjusted to a predetermined value ranging from 1.35 to 1.6.

The range of the refractive index as above is relatively close to a refractive index of quartz crystal or quartz glass, and thus is suitably used to bond optical components mainly made of quartz crystal or quartz glass.

Preferably, in the optical element of the aspect, the energy application includes at least one of application of an energy ray to the bonding film and exposure of the bonding film to plasma.

Using UV light as the energy allows a wide range to be evenly treated in a short time, whereby elimination of the leaving group can be efficiently performed. Furthermore, UV light can be produced by a simple device, such as a UV lamp.

Exposing the bonding film to plasma allows the energy to be applied selectively to a portion around the surface of the bonding film. Accordingly, adhesive properties can be generated at the surface of the bonding film, whereas it can be prevented that a composition, a volume and the like in the bonding film are changed.

Preferably, in the optical element, the energy ray is UV light having a wavelength ranging from 126 to 300 nm.

This amount of energy applied to the bonding film allows bonding between the Si skeleton and the leaving groups to be selectively cut off, while preventing excessive destruction of the Si skeleton in the bonding film. As a result, adhesive properties can be generated on the bonding film, while preventing reduction in the characteristics of the bonding film (mechanical characteristics, chemical characteristics, and the like).

Preferably, in the optical element, the plasma to which the bonding film is exposed is atmospheric pressure plasma.

Thereby, damage to the bonding film can be prevented, thereby allowing the bonding film to exhibit excellent adhesive properties and optical performance.

Preferably, in the optical element of the aspect, the first and the second optical components are made of quartz glass or quartz crystal.

These materials exhibit excellent adhesive properties against the bonding film, as well as have excellent transparent properties and excellent characteristics such as thermal resistance, light induced damage resistance, chemical resistance, and mechanical strength. Thus, the materials are particularly suitable as materials for the optical components.

Preferably, in the optical element of the aspect, the bonding film is formed such that a difference between the refractive index of the bonding film and the refractive index of the at least one of the first and the second optical components is less than 0.01.

Thereby, optically, the difference between the refractive indexes can be almost ignored, so that diffusion of light on a bonded interface can be surely suppressed, thus allowing the optical element obtained to have remarkable light transmission properties.

Preferably, in the optical element of the aspect, the film forming condition is a high frequency output.

Among film-forming conditions, the high frequency output is an easily and precisely adjustable parameter and thus is a control factor suitable to exactly adjust the refractive index.

Preferably, in the optical element of the aspect, the bonding film includes at least two bonding film layers formed between the first and the second optical components.

Thereby, the first and the second optical components can be more strongly bonded to each other.

According to a second aspect, there is provided a method for producing an optical element. The method includes preparing a first optical component and a second optical component each having light transmission properties and being adapted to be bonded together via a bonding film to form an optical element and forming the bonding film on a surface of the first optical component by plasma polymerization, the bonding film including an Si skeleton having a random atomic structure including a siloxane (Si—O) bond and leaving groups binding to the Si skeleton; applying energy to the bonding film to eliminate the leaving groups from the Si skeleton at the surface of the bonding film so as to provide adhesive properties; and bonding together the first and the second optical components via the bonding film to obtain the optical element, the bonding film having a refractive index adjusted so as to be approximately the same as a refractive index of at least one of the first and the second optical components by adjusting a film forming condition in the plasma polymerization.

The method can readily produce the optical element with high light resistance, high size precision, and high light transmission properties by bonding together the two optical components via the bonding film.

### BRIEF DESCRIPTION OF THE DRAWINGS

The invention will be described with reference to the accompanying drawings, wherein like numbers reference like elements.

FIGS. 1A to 1C are longitudinal sectional views explaining a method for producing an optical element according to a first embodiment.

FIGS. 2D and 2E are longitudinal sectional views explaining the method for producing an optical element of the first embodiment.

FIG. 3 is a partially enlarged view showing a state of a bonding film before energy application in the method for producing an optical element of the first embodiment.

FIG. 4 is a partially enlarged view showing a state of the bonding film after energy application in the method for producing an optical element of the first embodiment.

FIG. 5 is a longitudinal section view schematically showing a plasma polymerization apparatus used in the method for producing an optical element of the first embodiment.

FIGS. 6A to 6C are longitudinal section views explaining a method for forming the bonding film on a first optical component.

FIGS. 7A to 7D are longitudinal section views explaining a method for producing an optical element according to a second embodiment.

FIG. 8 is a perspective view of a wavelength plate.

### DESCRIPTION OF EXEMPLARY EMBODIMENTS

Hereinafter, an optical element and a method for producing the optical element will be described in detail by referring to the accompanying drawings.

The optical element of this embodiment includes two optical components (a first optical component 2 and a second optical component 4) and a bonding film 3 provided between the first and the second optical components 2 and 4. The two optical components 2 and 4 are bonded together by the bonding film 3 provided therebetween.

In the optical element, the bonding film 3 is formed by plasma polymerization and includes an Si skeleton having a random atomic structure including a siloxane (Si—O) bond and leaving groups binding to the Si skeleton.

When energy is applied to the bonding film 3 thus formed, some of the leaving groups present at the surface of the bonding film 3 are eliminated from the Si skeleton. Elimination of these leaving groups allows adhesive properties to be generated in a region of the bonding film 3 subjected to the applied energy.

The bonding film 3 having the characteristics as above can strongly bond the two optical components 2 and 4 to each other with high size precision and efficiently at a low temperature. By using the bonding film 3 thus formed, there can be obtained a highly reliable optical element in which the first and the second optical components 2 and 4 are strongly bonded together.

In addition, in the optical element of the embodiment, a refractive index of the bonding film 3 is adjusted so as to be approximately the same as a refractive index of the first and the second optical components 2 and 4. Adjustment of the refractive index can be performed by adjusting a film forming condition during the plasma polymerization. Accordingly, by appropriately setting up the film forming condition in accordance with the refractive index of the optical components 2 and 4, the bonding film 3 can be evenly formed with approximately the same refractive index as that of the optical components 2 and 4, without any variation. Thereby, there can be obtained an optical element having high light transmission properties.

### First Embodiment

Next, a description will be given of a method for producing an optical element according to a first embodiment.

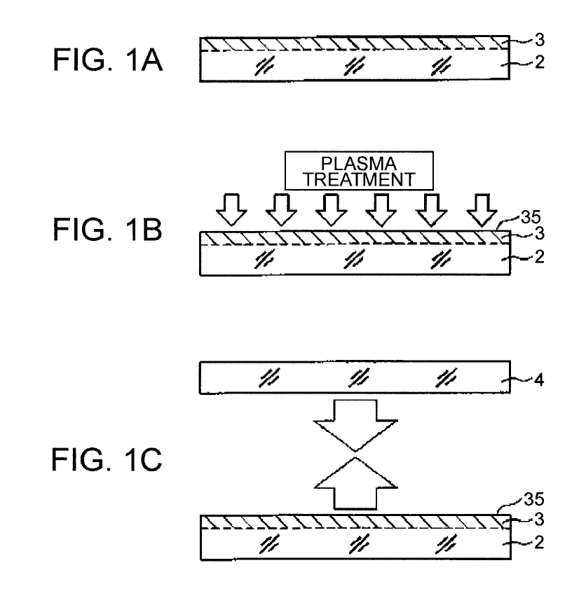

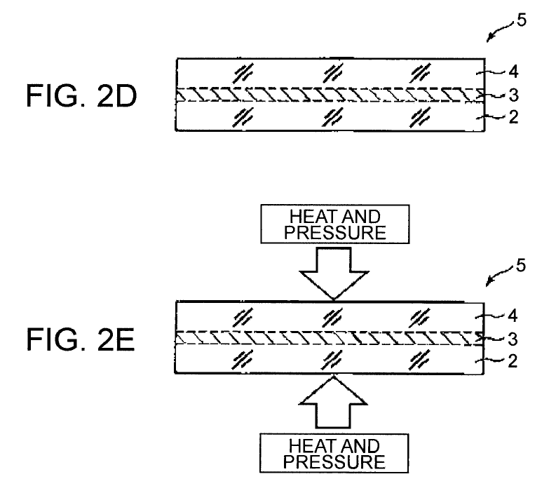

FIGS. 1A to 2E are longitudinal sectional views explaining the production method of the first embodiment. In the description below, upper and lower sides, respectively, in FIGS. 1A to 2E, will be referred to as “top” and “bottom”, respectively.

The method for producing an optical element of the first embodiment includes preparing the first and the second optical components 2 and 4 to form the bonding film 3 on a surface of the first optical component 2 by plasma polymerization (step 1); applying energy to the bonding film 3 (step 2); and bonding together the first and the second optical components 2 and 4 via the bonding film 3 to obtain a multi-layered optical element 5 (step 3). The steps will be sequentially described below.

1. First, the first and the second optical components 2 and 4 are prepared.

The optical components 2 and 4 are bonded together via the bonding film 3 to form the multi-layered optical element 5 having light transmission properties. Details of the multi-layered optical element 5 will be exemplified later.

The first optical component 2 is made of a light transmitting material. Examples of the light transmitting material include polyolefins such as polyethylene, polypropylene, ethylene-propylene copolymer, and ethylene-vinyl acetate copolymer (EVA); polyesters such as cyclo-polyolefin, modified-polyolefin, polyvinyl chloride, polyvinylidene chloride, polystyrene, polyamide (e.g. nylon 6, nylon 46, nylon 66, nylon 610, nylon 612, nylon 11, nylon 12, nylon 6-12, and nylon 6-66), polyimide, polyamide-imide, polycarbonate (PC), poly-(4-methylpentene-1), ionomer, acryl resin, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyethylene terephthalate (PET), polyethylene naphthalate, polybutylene terephthalate (PBT), and polycyclohexane terephthalate (PCT); thermosetting elastomers such as polyether, polyetherketone (PEK), polyether ether ketone (PEEK), polyetherimide, polyacetal (POM), polyphenyleneoxide, modified-polyphenyleneoxide, polysulfone, polyethersulfone, polyphenylene sulfide, polyarylate, aromatic polyester (liquid crystal polymer), polytetrafluoroethylene, polyvinylidene fluoride, other fluororesins, styrenes, polyolefins, polyvinyl chlorides, polyurethanes, polyesters, polyamides, polybutadienes, trans-polyisoprenes, fluoro rubbers, and chlorinated polyethylenes; resin materials such as epoxy resin, phenol resin, urea resin, melamine resin, unsaturated polyester, silicone resin, urethane resin, copolymers mainly containing them, polymer blends, and polymer alloys; glass materials such as soda-lime glass, quartz glass, lead glass, potash-lime glass, borosilicate glass, and non-alkali glass; and crystalline materials such as quartz crystal, calcite, sapphire, CaF₂, BaF₂, MgF₂, LiF, KBr, KCl, NaCl, MgO, YVO₄, and LiNbO₃.

Among these materials, silicon oxide materials such as quartz glass and quartz crystal are preferably used in the view of the compatibility of refractive index and adhesion (bondability) between the bonding film 3 and the first optical component 2. The silicon oxide materials also have excellent transparency, as well as excellent characteristics such as thermal resistance, light resistance, chemical resistance, and mechanical strength, and thus are particularly suitable as the material of the first optical component 2.

The second optical component 4 may be made of a material selected from the material examples of the first optical component 2 as desired, for example. The first and the second optical components 2 and 4 may be made of the same material or different materials. However, as described above, in the present embodiment, the material of each of the first and the second optical components 2 and 4 is selected in such a manner that the refractive index of the first optical component 2 is approximately the same as that of the second optical component 4.

In addition, an optical thin film may be formed on a surface of each of the first and the second optical components 2 and 4.

Next, as shown in FIG. 1A, the bonding film 3 is formed on the surface of the first optical component 2 (step 1). The bonding film 3 is located between the first and the second optical components 2 and 4 to bond the components to each other.

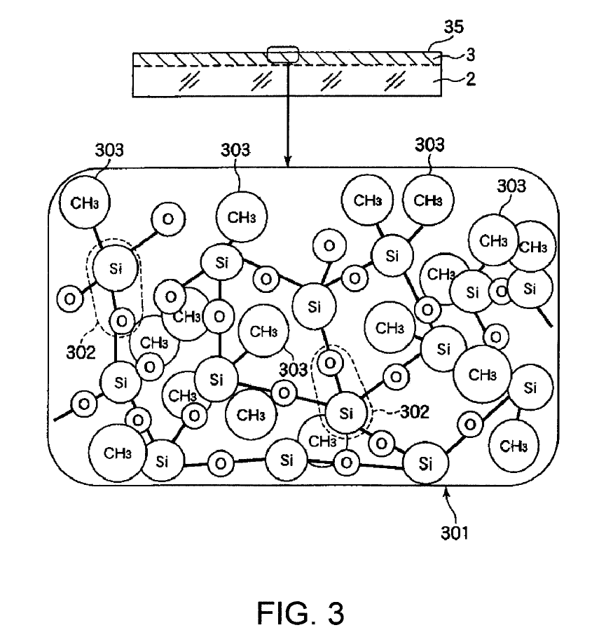

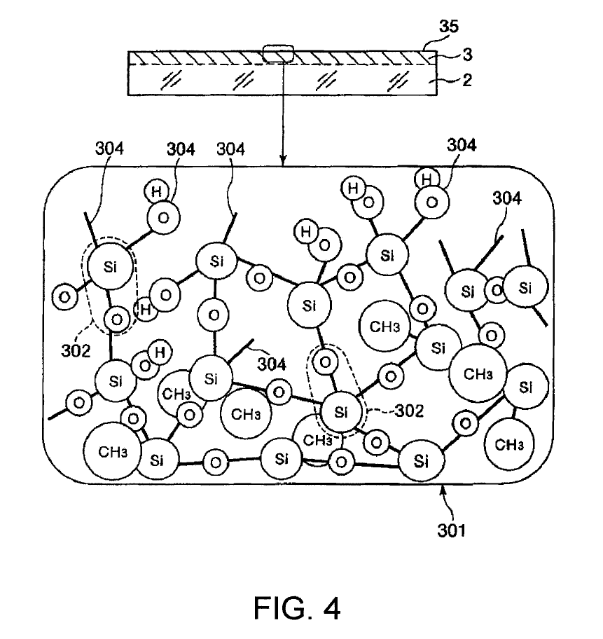

The bonding film 3 includes an Si skeleton 301 having a random atomic structure including a siloxane (Si—O) bond 302 and leaving groups 303 binding to the Si skeleton 301, as shown in FIGS. 3 and 4.

The bonding film 3 is formed by plasma polymerization. In forming the bonding film 3, by adjusting a film forming condition, the refractive index of the bonding film 3 is adjusted so as to be approximately the same as that of the first and the second optical components 2 and 4.

Details of the bonding film 3 will be described later.

On at least a region of the first optical component 2 intended to adhere to the bonding film 3, preferably, a surface treatment in accordance with the material of the first optical component 2 is performed before forming the bonding film 3 to increase the adhesion between the first optical component 2 and the bonding film 3.

The surface treatment may be a physical surface treatment such as sputtering or blast treatment, a plasma treatment using oxygen plasma or nitrogen plasma, a chemical surface treatment such as corona discharge, etching, electron beam radiation, UV radiation, ozone exposure, or a combination of these treatments. Performing such a surface treatment can lead to cleaning and activation of the region of the first optical component 2 intended to adhere to the bonding film 3. This can increase the bonding strength between the first optical component 2 and the bonding film 3.

Among the surface treatments mentioned above, using plasma treatment particularly enhances the surface of the first optical component 2 to adhere to the bonding film 3.

When the first optical component 2 to be surface-treated is made of a resin material (a high polymer material), corona discharge treatment or nitrogen plasma treatment may be particularly suitable.

Depending on the material of the first optical component 2, without any of the surface treatments, bonding strength against the bonding film 3 can be sufficiently increased. Examples of such effective materials for the first optical component 2 include those mainly containing the above-mentioned various kinds of glass materials and crystalline materials.

The surface of the first optical component 2 made of any of the above materials is covered with an oxide film, and a relatively highly active hydroxyl group is bonded to a surface of the oxide film. Accordingly, using the first optical component 2 made of such a material allows the adhesion strength between the first optical component 2 and the bonding film 3 to be increased without any surface treatment as mentioned above.

In that case, the entire first optical component 2 need not be made of a single one of the materials mentioned above. Instead, only a portion at a surface of the region of the first optical component 2 intended to adhere to the bonding film 3 may be made of the selected material.

Similarly, depending on the material of the second optical component 4, without any of the above surface treatments, the bonding strength between the first optical component 2 and the second optical component 3 can be sufficiently increased. Examples of such a material of the second optical component 4 exhibiting the above advantageous effect include the same materials as those for the first optical component 2, namely, glass materials and crystalline materials.

Additionally, when a region of the second optical component 4 intended to be closely adhered to the bonding film 3 includes a group or a substance as mentioned below, the bonding strength between the first and the second optical components 2 and 4 can be sufficiently increased without any of the surface treatments above.

The group or the substance may be at least one group or substance selected from functional groups such as a hydroxyl group, a thiol group, a carboxyl group, an amino group, a nitro group, and an imidazole group, unsaturated bonds such as radicals, ring-opened molecules, double bonds, and triple bonds, halogens such as F, Cl, Br and I, and peroxides.

Preferably, any of the surface treatments as mentioned above may be appropriately selected to obtain a surface including the at least one group or substance.

In addition, preferably, instead of the surface treatment, an intermediate layer is pre-formed on at least the region of the first optical component 2 intended to adhere to the bonding film 3 and on at least the region of the second optical component 4 intended to be closely adhered to the bonding film 3.

The intermediate layer may have any function. For example, the intermediate layer preferably has a function of increasing the adhesion to the bonding film 3, a cushioning function (a buffer function), a function of alleviating stress concentration, and the like. By using the intermediate layer having the functions, a highly reliable multi-layered optical element can be obtained.

For example, the intermediate layer thus formed may be made of any of metals such as aluminum and titanium, oxide materials such as an metal oxide and a silicon oxide, nitride materials such as a metal nitride and a silicon nitride, carbons such as graphite and diamond carbon, and self-organizing film materials such as a silane coupling agent, a thiol compound, a metal alkoxide, and a metal-halogen compound, resin materials such as resin adhesives, resin films, resin coating materials, rubber materials, and elastomers. Among these, a single kind or a combination of two or more kinds may be used as the material of the intermediate layer.

Among these kinds of the materials, using oxide materials as the material of the intermediate layer can particularly increase the bonding strength in the multi-layered optical element 5.

Next, as shown in FIG. 1B, energy is applied to the bonding film 3.

By application of the energy, the leaving groups 303 are eliminated from the Si skeleton 301 at the surface of the bonding film 3. Then, an active bond occurs at a portion where the leaving groups 303 are eliminated, thereby causing the bonding film 3 to have stable adhesive properties to the second optical component 4. As a result, the bonding film 3 can be stably and strongly bonded to the second optical component 4 based on chemical bonding.

As shown in FIG. 3, before application of the energy, the bonding film 3 has the Si skeleton 301 and the leaving groups 303. When the energy is applied to the bonding film 3, the leaving groups 303 (methyl groups in the present embodiment) near the surface of the film are eliminated from the Si skeleton 301. As such, as shown in FIG. 4, an active bond 304 occurs along a surface 35 of the bonding film 3 to allow activation of the bonding film 3, so that the surface 35 of the bonding film 3 has adhesive properties.

The “activation” of the bonding film 3 means a condition where the leaving groups 303 at the surface 35 of and inside the bonding film 3 are eliminated and thereby a non-terminated bond (hereinafter referred to as “broken bond” or “dangling bond”) occurs in the Si skeleton 301, a condition where the broken bond has a hydroxyl group (an OH group) at an end thereof; or a condition where these conditions occur together.

Thus, the active bond 304 is referred to as the broken bond (the dangling bond) or the broken bond having an OH group at an end thereof. By using the active bond 304, particularly strong bonding can be achieved between the bonding film 3 and the second optical component 4.

As methods for applying the energy to the bonding film 3, for example, there may be mentioned a method for applying an energy ray to the bonding film 3, or a method for exposing the bonding film 3 to plasma.

Examples of the energy ray applied to the bonding film 3 include a light ray such as ultraviolet (UV) light or laser light, a particle ray such as an X ray, a gamma ray, or an ion beam, and a combination of these energy rays.

Among the examples, preferably, UV light having a wavelength ranging from 126 to 300 nm is used. Using the UV light having a wavelength in this range allows a select amount of energy to be applied. Thus, while preventing excessive destruction of the Si skeleton 301 in the bonding film 3, bonding between the Si skeleton and the leaving groups 303 can be selectively cut off. As a result, the bonding film 3 can be adhesive while preventing a reduction in the characteristics (such as mechanical characteristics and chemical characteristics) of the bonding film 3.

In addition, using such UV light allows treatment of a wide area of the bonding film 3 to be made evenly in a short time, so that the leaving groups 303 can be efficiently eliminated from the surface. Furthermore, for example, UV light is advantageous in that UV light can be produced by a simple device, such as a UV lamp.

The wavelength of the UV light ranges more preferably from 160 to 200 nm.

When using a UV lamp, the output intensity of the UV lamp varies depending on an area of the bonding film 3, and ranges preferably from 1 mW/cm² to 1 W/cm², and more preferably from 5 mW/cm² to 50 mW/cm². In this case, a distance between the UV lamp and the bonding film 3 ranges preferably from 3 to 3000 mm, and more preferably from 10 to 1000 mm.

The time (duration) for applying the UV light is preferably set to a time allowing elimination of the leaving groups 303 near the surface 35 of the bonding film 3, namely a time not allowing too much elimination of the leaving groups 303 in the bonding film 3. Specifically, the time for applying the UV light ranges preferably from 0.5 to 30 minutes and more preferably from 1 to 10 minutes, although the time varies more or less depending on an amount of the UV light, the material of the bonding film 3, and the like.

Additionally, the UV light may be applied continuously for a predetermined time or intermittently (by a predetermined pulse width).

Meanwhile, as laser light, for example, there may be mentioned excimer laser (femto-second laser), Nd—YAG laser, Ar laser, CO₂ laser, and He—Ne laser.

In addition, the UV light can be applied to the bonding film 3 in any atmosphere. Specifically, the UV light may preferably be applied in an atmosphere of oxidizing gas such as air or oxygen, an atmosphere of reducing gas such as hydrogen, an atmosphere of inert gas such as nitrogen or argon, or a pressure-reduced (vacuum) atmosphere obtained by reducing any of the atmospheres, for example. These atmospheres can prevent degeneration and deterioration of the bonding film 3 due to oxidation of the film.

Furthermore, the atmosphere for application of the UV light is preferably a dry atmosphere. This can prevent atmospheric water vapor from adsorbing to a place where chemical bonding has been cut off by application of the UV light, thereby preventing an unintended change in the composition of the bonding film 3.

Specifically, the atmosphere has a dew point, preferably equal to or less than minus 10° C., and more preferably equal to or less than minus 20° C.

Furthermore, by applying the energy ray, a magnitude of the energy applied can be adjusted easily with high precision, thereby allowing adjustment of the amount of leaving groups 303 eliminated from the bonding film 3. Consequently, the bonding strength in the multi-layered optical element 5 can be easily controlled.

Specifically, when the amount of the leaving groups 303 eliminated is increased, many more active bonds are generated at the surface 35 of and inside the bonding film 3, thus further increasing the adhesion occurring on the bonding film 3. Conversely, by reducing the amount of the leaving group 303 eliminated, the amount of active bonds generated at the surface 35 of and inside the bonding film 3 is reduced, thereby enabling the adhesion generated on the bonding film 3 to be suppressed.

The magnitude of the energy applied may be adjusted by adjustment of kind, output intensity, application time, and the like of the energy ray, for example.

On the other hand, in the exposure of the bonding film 3 to plasma, the energy can be selectively applied to the portion around the surface 35 of the bonding film 3, which can prevent too many of the leaving groups 303 from being eliminated from the interior of the bonding film 3. Consequently, the surface 35 of the bonding film 3 can surely become adhesive, and it can be prevented that, inside the bonding film 3, the elimination of the leaving groups 303 causes undesirable changes in the composition, the volume, the refractive index, and the like of the bonding film 3.

In this case, preferably, the plasma to which the bonding film 3 is exposed is atmospheric-pressure plasma. Use of atmospheric-pressure plasma does not require any expensive equipment such as a pressure-reducing unit, thus facilitating plasma treatment. Other preferable examples of the plasma treatment include a direct plasma method generating plasma near the bonding film 3, a remote plasma method and a down-flow plasma method performed in a condition in which a target object to be plasma-treated is spaced apart from a plasma generating section. In the direct plasma method in which plasma is generated near the bonding film 3, the plasma treatment can be efficiently and evenly performed. In addition, in the methods in which the target object and the plasma generating section are spaced apart from each other, no interference occurs between the target object and the plasma generating section, thus preventing the target object from being damaged by plasma ions.

Furthermore, if the plasma treatment is performed in a pressure-reduced atmosphere, there may be concerns that undesirably-trapped gas in the bonding film 3, gas occurring with time, or the like may be forcibly drawn out of the bonding film 3. Such a phenomenon causes damage to the bonding film 3, thereby reducing adhesion strength and optical performance.

In contrast, performing the plasma treatment at atmospheric pressure can prevent damage to the bonding film 3, so that the bonding film 3 can obtain high adhesion properties and high optical performance.

Examples of plasma-generating gas include Ar, He, H₂, N₂, O₂, and a mixture of at least two kinds thereof. Among these, preferably, an inert gas such as Ar or He is used in consideration of oxidation of the bonding film 3 or the like.

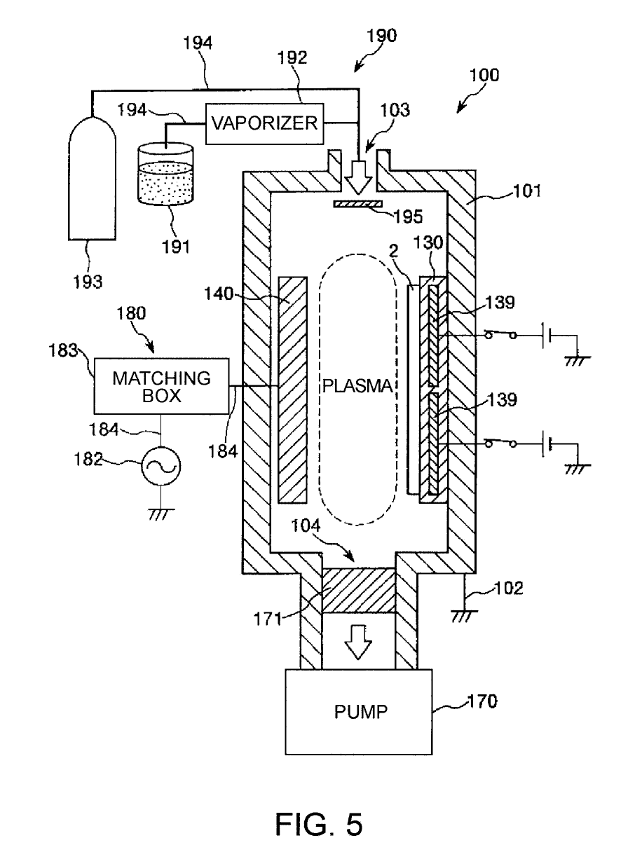

The plasma treatment may be performed by using a plasma polymerization apparatus 100 shown in FIG. 5 described later. Specifically, after forming the bonding film 3 by the plasma polymerization apparatus 100 of FIG. 5, the plasma treatment of the present step can be sequentially performed without removing the first optical component 2 with the bonding film 3 formed thereon from the plasma polymerization apparatus 100. This can simplify the method for producing an optical element according to the embodiment.

When generating plasma by electric discharge, a voltage applied between electrodes preferably is a voltage with a high frequency of MHz or higher. Thereby, as compared to DC discharge, the discharge start voltage is reduced, so that the discharging condition can be easily maintained. Additionally, using a high frequency voltage increases a degree of ionization in the plasma, resulting in an increase in plasma density. As a result, the elimination of the leaving groups 303 by plasma can be efficiently performed.

The voltage frequency applied between the electrodes is not restricted to a specific level, but ranges preferably from 10 to 50 MHz and more preferably from 10 to 40 MHz.

Additionally, as the method for applying the energy in step 2, besides the methods described above, there may be mentioned heating, pressurization, exposure to ozone, and the like.

Although described above, the bonding film 3 before the energy application includes the Si skeleton 301 and the leaving groups 303 (FIG. 3), but after the energy application, some of the leaving groups 303 (a methyl group in the embodiment) are eliminated from the Si skeleton 301, whereby the active bond 304 is generated at the surface 35 of the bonding film 3 to activate the bonding film 3 (FIG. 4). As a result, adhesive properties are provided along the surface 35 of the bonding film 3.

Additionally, when the bonding film 3 is “activated”, elimination of the leaving groups 303 at the surface 35 of and inside the bonding film 3 generates non-terminated bonds (namely, “broken bonds” or “dangling bonds”) in the Si skeleton 301; the broken bonds have a hydroxyl group (an OH group) at an end of each thereof; or those conditions occur together.

Accordingly, the active bond 304 is equivalent to the broken bond (the dangling bond) or the broken bond having an OH group at an end thereof. The occurrence of the active bond 304 allows the first and the second optical components 2 and 4 to be more strongly bonded together via the bonding film 3.

3. Next, as shown in FIG. 1C, the first and the second optical components 2 and 4 are bonded together such that the activated bonding film 3 is closely adhered to the second optical component 4, so as to obtain the multi-layered optical element 5 as shown in FIG. 2D (step 3).

In the multi-layered optical element 5 thus obtained, the components 2 and 4 are bonded to each other via the bonding film 3 not by adhesion mainly based on physical bonding such as an anchor effect, as in adhesives used in conventional optical element producing methods, but by strong chemical bonding occurring in a short time, such as a covalent bond. Accordingly, the multi-layered optical element 5 can be formed in a short time, as well as separation between the components is almost impossible and bonding unevenness or the like hardly occurs.

Furthermore, in the method of the embodiment, it is unnecessary to perform thermal treatment at high temperature (e.g. 700° C. or higher), as in conventional solid-to-solid bonding methods. Accordingly, the method of the embodiment can achieve bonding between the first and the second optical components 2 and 4 each made of a low heat-resistant material.

Still furthermore, since the first and the second optical components 2 and 4 are bonded together via the bonding film 3, there is an advantage that the material of each of the optical components 2 and 4 is not specifically restricted.

Therefore, in the embodiment, the first and the second optical components 2 and 4 may each be selected from various materials.

Additionally, in the embodiment, the bonding film 3 is formed only on one of the first and the second optical components 4 that are to be bonded together (only on the first optical component 2 in the embodiment). In order to form the bonding film 3 on the first optical component 2, depending on the method for forming the bonding film 3, the first optical component 2 may be exposed to plasma for a relatively long time, although the second optical component 4 is not exposed to plasma in the embodiment. Thus, for example, even if the second optical component 4 has extremely low resistance to plasma, the method of the embodiment can achieve strong bonding between the first and the second optical components 2 and 4. Thus, there is another advantage that the material of the second optical component 4 can be selected from a wide range of materials, with almost no consideration to plasma resistance.

Now, a description will be given of a mechanism of bonding between the first and the second optical components 2 and 4 in the present step.

There will be described one example in which a hydroxyl group is exposed on a bonded surface of the second optical component 4. In the present step, when the surface 35 of the bonding film 3 is bonded to the bonded surface of the second optical component 4 so as to contact the surfaces with each other, the hydroxyl group at the surface 35 of the bonding film 3 and the hydroxyl group at the bonded surface of the second optical component 4 pull against each other by hydrogen bonding, causing an attractive force between the hydroxyl groups. The attractive force seems to serve to bond together the first and the second optical components 2 and 4.

The hydroxyl groups pulling against each other by the hydrogen bonding are dehydrated and condensed depending on conditions such as temperature. As a result, the hydrogen groups are bonded to each other via an oxygen atom on a contact interface between the first and the second optical components 2 and 4. This seems to increase the strength of the bonding between the first and the second optical components 2 and 4.

The activated condition of the surface of the bonding film 3 activated at step 2 is alleviated as time passes (deteriorates over time). Thus, preferably, the present step, namely, step 3, is performed as immediately as possible after completion of the previous step, namely, step 2. Specifically, step 3 is performed, preferably, within 60 minutes after step 2, and more preferably within five minutes after step 2. The surface 35 of the bonding film 3 maintains a sufficiently activated condition within this time duration. Accordingly, at the present step, when the first and the second optical components 2 and 4 are bonded together, the bonding therebetween can be made sufficiently strong.

In other words, the bonding film 3 before activation is a bonding film including the Si skeleton 301, so that the bonding film 3 is chemically relatively stable and highly environmentally-resistant. Thus, the bonding film 3 before being activated is suitable for long-term preservation. Accordingly, from a viewpoint of production efficiency of the multi-layered optical element 5, it is useful to produce or purchase and preserve a large number of first optical components 2 with the bonding film 3 thus formed thereon, and then, perform the energy treatment described at step 2 only on necessary pieces of the first optical components 2 immediately before bonding the components 2 and 4 together at the present step.

In the manner described above, there can be obtained the optical element 5, as shown in FIG. 2D.

In FIG. 2D, the second optical component 4 is placed on the bonding film 3 so as to cover an entire part of the surface 35 of the bonding film 3. However, there may be a deviation in relative positions between the surface 35 thereof and the second optical component 4. For example, the second optical component 4 may protrude from an edge of the bonding film 3.

In the multi-layered optical element 5 thus obtained, the bonding strength between the first and the second optical components 2 and 4 is preferably equal to or more than 5 MPa (50 kgf/cm²), and is more preferably equal to or more than 10 MPa (100 kgf/cm²). In the multi-layered optical component 5 having the above bonding strength, separation between the components 2 and 4 can be sufficiently prevented.

After obtaining the multi-layered optical element 5, at least one of following two steps 4A and 4B (as a step of increasing the bonding strength in the multi-layered optical element 5) may be performed on the multi-layered optical element 5, as desired. Thereby, the bonding strength in the multi-layered optical element 5 can be further improved.

At step 4A, as shown in FIG. 2E, the multi-layered optical element 5 obtained is pressurized in a direction in which the first and the second optical components 2 and 4 come close to each other (toward one another).

Thereby, the respective surfaces of the bonding film 3 come closer to the corresponding surfaces of the first and the second optical components 2 and 4, thus increasing the bonding strength in the multi-layered optical element 5.

In addition, with pressurization of the multi-layered optical element 5, space remaining between bonded interfaces in the multi-layered optical element 5 can be crushed, so that a bonded area can be further increased. As a result, the bonding strength in the multi-layered optical element 5 can be further increased.

Preferably, the level of a pressure applied to the multi-layered optical element 5 is set to be as high as possible within a range not causing any damage to the multi-layered optical element 5. This can increase the bonding strength in the multi-layered optical element 5 in proportion to the level of the pressure applied.

The pressure to be applied may be appropriately adjusted in accordance with conditions such as the material and thickness of each of the first and the second optical components 2, 4 and a bonding device. Specifically, the pressure is preferably approximately 0.2 to 10 MPa and more preferably approximately 1 to 5 MPa, although the preferable pressure range varies more or less depending on the material, the thickness, and the like of the first and the second optical components 2 and 4. This can surely increase the bonding strength in the multi-layered optical element 5. Furthermore, the pressure to be applied may exceed an upper limit value of the above range, although damage or the like may be caused to the first and the second optical components 2 and 4 depending on the materials thereof.

The pressurization time is not specifically restricted, but is preferably approximately 10 seconds to 30 minutes. The pressurization time may be appropriately changed in accordance with a pressure to be applied. Specifically, for example, by reducing the pressurization time along with an increase in the pressure applied to the multi-layered optical element 5, the bonding strength can be improved.

At step 4B, as shown in FIG. 2E, the obtained multi-layered optical element 5 is heated.

Thereby, the bonding strength in the multi-layered optical element 5 can be further increased.

In this case, the temperature for heating the multi-layered optical element 5 is not specifically restricted as long as the temperature is higher than room temperature and lower than a heat resistance temperature of the multi-layered optical element 5. The heating temperature is preferably approximately 25 to 100° C. and more preferably approximately 50 to 100° C. Heating the multi-layered optical element 5 within the above temperature range can surely increase the bonding strength while preventing heat-induced degeneration or deterioration in the multi-layered optical element 5.

The heating time is not specifically restricted, but is preferably approximately 1 to 30 minutes.

In addition, when performing both of steps 4A and 4B, the steps are preferably simultaneously performed. In short, as shown in FIG. 2E, preferably, the multi-layered optical element 5 is heated while being pressurized. This allows the pressurization effect and the heating effect to be synergistically exhibited, which particularly can increase the bonding strength in the multi-layered optical element 5.

By going through the steps described above, the bonding strength in the multi-layered optical element 5 can be easily further increased.

Next, details of the bonding film 3 will be described.

As described above, the bonding film 3 is formed by plasma polymerization. As shown in FIG. 3, the bonding film 3 includes the Si skeleton 301 having a random atomic structure including the siloxane (Si—O) bond 302 and the leaving groups 303 binding to the Si skeleton 301. The bonding film 3 thus formed becomes a strong film that is hardly deformed, due to influence of the Si skeleton 301 having the random atomic structure including the siloxane (Si—O) bond 302. Since the Si skeleton 301 has low crystallization, defects such as displacement or deviation in a crystal grain boundary hardly occur. For this reason, the bonding film 3 in itself can obtain high bonding strength, high chemical resistance, high light-induced damage resistance, and high size precision. Accordingly, the multi-layered optical element 5 finally obtained can also be excellent in bonding strength, chemical resistance, light induced damage resistance, and size precision.

When the energy is applied to the bonding film 3 thus formed, some of the leaving groups 303 are eliminated from the Si skeleton 301, whereby active bonds 304 occur at the surface 35 of and the inside of the bonding film 3, as shown in FIG. 4. Thereby, the surface 35 of the bonding film 3 obtains adhesion properties. With the occurrence of the adhesion properties, the bonding film 3 can be strongly and efficiently bonded to the second optical component 4 with high size precision.

The bonding energy between the leaving groups 303 and the Si skeleton 301 is smaller than bonding energy of the siloxane bond 302 in the Si skeleton 301. Accordingly, by the application of the energy to the bonding film 3, bonding between the leaving groups 303 and the Si skeleton 301 can be selectively cut off to eliminate some of the leaving groups 303, while preventing destruction of the Si skeleton 301.

In addition, the bonding film 3 thus formed is a solid having no fluidity. Thus, as compared to conventional liquid or mucous adhesives having fluidity, the thickness and the shape of a bonding layer (the bonding film 3) are hardly changed. Thereby, the size precision of the multi-layered optical element 5 is much higher than in conventional multi-layered optical elements. Furthermore, there is no need for adhesive-curing time, so that strong bonding can be achieved in a short time.

In the bonding film 3, particularly, regarding all atoms other than H atoms included in the bonding film 3, a sum of a content of Si atoms and a content of O atoms ranges preferably from 10 to 90 atom percent, and more preferably from 20 to 80 atom percent. When the total content of the Si atoms and the O atoms is in the above range, the bonding film 3 has a strong network of the Si atoms and the O atoms, thereby allowing the bonding film 3 to be strong. Additionally, the bonding film 3 thus formed exhibits particularly high bonding strength when bonded to each of the first and the second optical components 2 and 4.

The ratio of the Si atoms and the O atoms included in the bonding film 3 ranges preferably from 3:7 to 7:3, and more preferably from 4:6 to 6:4. Setting the ratio of the Si atoms and the O atoms in the above range can increase stability of the bonding film 3, whereby the first and the second optical components 2 and 4 can be more strongly bonded together.

The degree of crystallization of the Si skeleton 301 is preferably equal to or less than 45% and more preferably equal to or less than 40%. This allows the Si skeleton 301 to have a sufficiently random atomic structure. Consequently, the characteristics of the Si skeleton 301 mentioned above become apparent, so that the bonding film 3 can obtain higher size precision and higher adhesion properties.

The degree of crystallization of the Si skeleton 301 can be measured by any of general crystallization measuring methods. Specifically, examples of such methods include a measuring method based on intensity of a scattered X-ray in a crystallized portion (an X-ray method), a measuring method based on intensity of a crystallization band of infrared absorption (an infrared ray method), a measuring method based on an area below a differential curve of a nuclear magnetic resonance absorption (a nuclear magnetic resonance absorption method), and a chemical method using a fact that chemical reagents hardly infiltrate in any crystallized portion.

Additionally, preferably, the bonding film 3 includes an Si—H bond in its structure. The Si—H bond is generated in a polymer in polymerization reaction of silane caused by plasma polymerization. In this case, the Si—H bond seems to inhibit a siloxane bond from being regularly generated. Thereby, the siloxane bond is formed so as to avoid the Si—H bond, thus reducing the regularity of the atomic structure of the Si skeleton 301. In this manner, by using plasma polymerization, an Si skeleton 301 having a low degree of crystallization can be efficiently formed.

Meanwhile, the degree of crystallization of the Si skeleton 301 is not reduced even if the content of the Si—H bond included in the bonding film 3 is increased. Specifically, in an infrared absorption spectrum of the bonding film 3, when a peak intensity of the siloxane bond is set to 1, a peak intensity of the Si—H bond ranges preferably from 0.001 to 0.2, more preferably from 0.002 to 0.05, and still more preferably from 0.005 to 0.02. Setting a ratio of the Si—H bond to the siloxane bond in the above range allows the atomic structure in the bonding film 3 to be the most random, relative to the ratio. Thus, when the peak intensity of the Si—H bond with respect to the peak intensity of the siloxane bond is within the above range, the bonding film 3 can be made particularly excellent in bonding strength, chemical resistance, and size precision.

As described above, the leaving groups 303 binding to the Si skeleton 301 acts so as to cause generation of the active bonds in the bonding film 3 by being selectively eliminated from the Si skeleton 301. Accordingly, it is desirable for the leaving groups 303 to surely bind to the Si skeleton 301 so as not to be eliminated therefrom when no energy is applied, but are eliminated relatively easily and evenly when energy is applied.

In formation of the bonding film 3 using plasma polymerization, polymerization reaction of a component of a raw material gas results in generation of the Si skeleton 301 including the siloxane bond and a residue binding to the Si skeleton 301. The residue may be the leaving groups 303, for example.

Preferably, the leaving groups 303 may include at least one of an H atom, a B atom, a C atom, an N atom, an O atom, a P atom, an S atom, and a halogen atom, and an atomic group in which each of the atoms is arranged so as to bind to the Si skeleton 301. The leaving groups 303 are relatively excellent in selectivity of binding or elimination by application of energy. Thus, the leaving groups 303 as above can sufficiently satisfy the need described above, thereby further improving the adhesion properties of the bonding film 3.

Examples of the atomic group (group) including the atoms arranged so as to be bind to the Si skeleton 301 include an alkyl group such as a methyl group or an ethyl group, an alkenyl group such as a vinyl group or an allyl group, an aldehyde group, a ketone group, a carboxyl group, an amino group, an amide group, a nitro group, a halogen-substituted alkyl group, a mercapto group, a sulfonic acid group, a cyano group, and an isocyanate group.

Among the groups, the leaving groups 303 are preferably alkyl groups. The alkyl group is chemically stable, so that a bonding film 3 including the alkyl-group exhibits high environment resistance and high chemical resistance.

When the leaving groups 303 are a methyl group (—CH₃), a preferable content of the methyl group is determined as below, based on peak intensity in the infrared absorption spectrum.

Specifically, in the infrared absorption spectrum of the bonding film 3, when a peak intensity of the siloxane bond is set to 1, a peak intensity of the methyl group ranges preferably from 0.05 to 0.45, more preferably from 0.1 to 0.4, and still more preferably from 0.2 to 0.3. By setting a ratio of the peak intensity of the methyl group to the peak intensity of the siloxane bond in the above range, the methyl group can be prevented from excessively inhibiting generation of the siloxane bond, and a desired and sufficient number of active bonds are generated in the bonding film 3, thereby allowing the bonding film 3 to obtain sufficient adhesion properties. In addition, the bonding film 3 can obtain sufficient environmental resistance and chemical resistance attributed to the methyl group.

As the material of the bonding film 3 thus characterized, for example, there may be mentioned a polymer including a siloxane bond such as polyorganosiloxane and an organic group as the leaving group 303 binding to the siloxane bond.

The bonding film 3 made of polyorganosiloxane has excellent mechanical characteristics in itself, and exhibits particularly high adhesion to many materials. Accordingly, the bonding film 3 made of polyorganosiloxane is particularly strongly adhered to both of the first and the second optical components 2 and 4, resulting in achieving strong bonding between the optical components 2 and 4.

In polyorganosiloxane, which usually exhibits hydrophobic (non-adhesive) properties, an organic group is easily eliminated when energy is applied, and thereby, the polyorganosiloxane is changed to be hydrophilic to exhibit adhesive properties. Thus, polyorganosiloxane has an advantage that control between non-adhesion and adhesion can be easily and surely performed.

The hydrophobic (non-adhesive) properties occur mainly due to an effect of an alkyl group included in polyorganosiloxane. Accordingly, using the bonding film 3 made of polyorganosiloxane is advantageous in that application of energy allows the surface 35 to become adhesive, as well as allows regions of the bonding film 3 other than the surface 35 to exhibit the effect and the advantage of the alkyl group described above. Accordingly, the bonding film 3 thus formed has high environmental resistance and high chemical resistance, and for example, is effectively used for assembly of optical elements exposed to chemicals or the like for a long period of time.

Among various kinds of polyorganosiloxanes, particularly, a preferable polyorganosiloxane mainly contains a polymer of octamethyltrisiloxane. The bonding film 3 mainly made of the polymer of octamethyltrisiloxane has particularly high adhesion properties. In addition, a material containing octamethyltrisiloxane as a main component is in liquid form at room temperature and has moderate viscosity. Thus, there is an advantage that such a material can be easily used.

A mean thickness of the bonding film 3 ranges preferably from 1 to 1000 nm and more preferably from 2 to 800 nm. Using the bonding film having a mean thickness set in the above range can prevent significant reduction in the size precision of the multi-layered optical element 5, as well as can further increase the bonding strength in the multi-layered optical element 5.

Conversely, when the mean thickness of the bonding film 3 is below the lowest limit value of the range, the bonding strength may be insufficient. Meanwhile, when the bonding film 3 has a mean thickness above the upper limit value of the range, the size precision of the multi-layered optical element 5 may be reduced.

Furthermore, the bonding film 3 having the mean thickness set in the above range maintains shape followability to some extent. Accordingly, for example, even if the bonding surface of the first optical component 2 (the surface facing the bonding film 3) has an uneven portion, the bonding film 3 can be adhered so as to follow along a shape of the uneven portion, although it depends on the height of the uneven portion. As a result, the bonding film 3 covers the unevenness of the portion, thereby reducing the height of the uneven portion formed on the surface of the film. Then, when the first optical component 2 is adhered to the second optical component 4, adhesiveness between the components 2 and 4 can be increased.

The degree of the shape followability as mentioned above becomes more apparent as the thickness of the bonding film 3 is increased. Thus, in order to ensure sufficient shape followability, the thickness of the bonding film 3 may be made as large as possible.

Preferably, the bonding film 3 has a mean thickness equal to or less than a wavelength of light transmitted through the multi-layered optical element 5. Thereby, in the multi-layered optical element 5, optical influence of the bonding film 3 on the light transmitted can be reduced.

Hereinabove, the details of the bonding film 3 have been described. The bonding film 3 described above is formed by plasma polymerization. Plasma polymerization can efficiently produce the bonding film 3 as an elaborate and homogeneous film. Thereby, the bonding film 3 can be particularly strongly bonded to the second optical component 4. In addition, the bonding film 3 formed by plasma polymerization maintains the activated state by the application of energy for a relatively long time. This can simplify a production process of the multi-layered optical element 5 to make the production process more efficient.

Next, a method for forming the bonding film 3 will be described.

First, before describing the bonding film forming method, the plasma polymerization apparatus will be described. The plasma polymerization apparatus is used to form the bonding film 3 on the first optical component 2 by plasma polymerization.

FIG. 5 is a longitudinal section view schematically showing the plasma polymerization apparatus 100 used in the optical element producing method of the embodiment. In the description below, upper and lower sides, respectively, in FIG. 5, will be referred to as “top” and “bottom”, respectively.

The plasma polymerization apparatus 100 shown in FIG. 5 includes a chamber 101, a first electrode 130 supporting the first optical component 2, a second electrode 140, a power supply circuit 180 applying a high frequency voltage between the electrodes 130 and 140, a gas supplying section 190 supplying gas into the chamber 101, and an exhaustion pump 170 exhausting the gas present in the chamber 101. Among these components, the first and the second electrodes 130 and 140 are provided inside the chamber 101. Each of the components included in the apparatus 100 will be described in detail below.

The chamber 101 is a container that can maintain the air tightness of an inside thereof and is used in a condition where pressure inside the chamber is reduced (namely, in a vacuum condition). Accordingly, the chamber 101 is structured so as to have pressure-resistant capability enough to be resistant against a pressure difference between the inside and the outside of the chamber.

The chamber 101 shown in FIG. 5 includes a chamber main body having an approximately cylindrical shape whose axial line is arranged in a horizontal direction, a circular side wall sealing a left opening portion of the chamber main body, and a circular side wall sealing a right opening portion thereof.

At a top of the chamber 101 is provided a supply outlet 103 and at a bottom thereof is provided an exhaustion outlet 104. The supply outlet 103 is connected to a gas supplying section 190, and the exhaustion outlet 104 is connected to the exhaustion pump 170.

In the present embodiment, the chamber 101 is made of a highly conductive metal and is electrically grounded via a ground line 102.

The first electrode 130 has a plate shape and supports the first optical component 2.

The first electrode 130 is vertically provided on an inner wall surface of one of the side walls of the chamber 101 to be electrically grounded via the chamber 101. As shown in FIG. 5, the first electrode 130 is arranged concentrically with respect to the chamber main body.

On a surface of the first electrode 130 supporting the first optical component 2 is provided an electrostatic chuck (an adsorption mechanism) 139.

The electrostatic chuck 139 allows the first optical component 2 to be vertically supported, as shown in FIG. 5. Even if some warpage occurs on the first optical component 2, the first optical component 2 is adsorbed by the electrostatic chuck and thus can be subjected to plasma treatment in a condition where the warpage has been corrected.

The second electrode 140 is provided facing the first electrode 130 via the first optical component 2. The second electrode 140 is spaced apart (insulated) from an inner wall surface of the other side wall of the chamber 101.

The second electrode 140 is connected to a high frequency power supply 182 via a wiring 184. At a predetermined point of the wiring 184 is provided a matching box (a matching unit) 183. The wiring 184, the high frequency power supply 182, and the matching box 183 form the power supply circuit 180.

Since the first electrode 130 is grounded, the power supply circuit 180 applies a high frequency voltage between the first and the second electrodes 130 and 140, whereby an electric field whose direction is reversed at high frequency is induced in a space between the first and the second electrodes 130 and 140.

The gas supplying section 190 supplies a predetermined gas into the chamber 101.

The gas supplying section 190 shown in FIG. 5 includes a liquid reservoir section 191 reserving a liquid film material (a raw liquid), a vaporizer 192 vaporizing the liquid film material to change the material into gas, and a gas cylinder 193 storing a carrier gas. These components are connected to the supply outlet 103 of the chamber 101 via the pipe 194 such that a mixture gas of a gaseous film material (a raw gas) and the carrier gas is supplied from the supply outlet 103 into the chamber 101.

The liquid film material reserved in the reservoir section 191 is a raw material used to form a polymerization film on the surface of the first optical component 2 by polymerization using the plasma polymerization apparatus 100.

The liquid film material is vaporized by the vaporizer 192 to be changed into the gaseous film material (the raw gas) and supplied into the chamber 101. The raw gas will be described in detail later.

The carrier gas stored in the gas cylinder 193 is introduced to cause and maintain discharge by effect of the electric field. The carrier gas may be an Ar gas, an He gas, or the like, for example.

Near the supply outlet 103 of the chamber 101 is disposed a diffusion plate 195.

The diffusion plate 195 serves to promote diffusion of the mixture gas supplied into the chamber 101, whereby the mixture gas can be diffused with approximately even concentration in the chamber 101.

The exhaustion pump 170 exhausts the chamber 101. For example, the exhaustion pump 170 may be an oil-sealed rotary pump or a turbo-molecular pump. In this manner, exhausting the chamber 101 to reduce pressure thereinside can facilitate plasmatization of gas and can prevent contamination, oxidation, or the like of the first optical component 2 caused by contact with air. Additionally, a reaction product formed by plasma treatment can be effectively removed from the chamber 101.

Furthermore, the exhaustion outlet 104 has a pressure control mechanism 171 adjusting pressure in the chamber 101. Thereby, the pressure inside the chamber 101 can be appropriately set in accordance with an operation status of the gas supplying section 190.

Next will be described the method for forming the bonding film 3 on the first optical component 2 by the plasma polymerization apparatus 100.

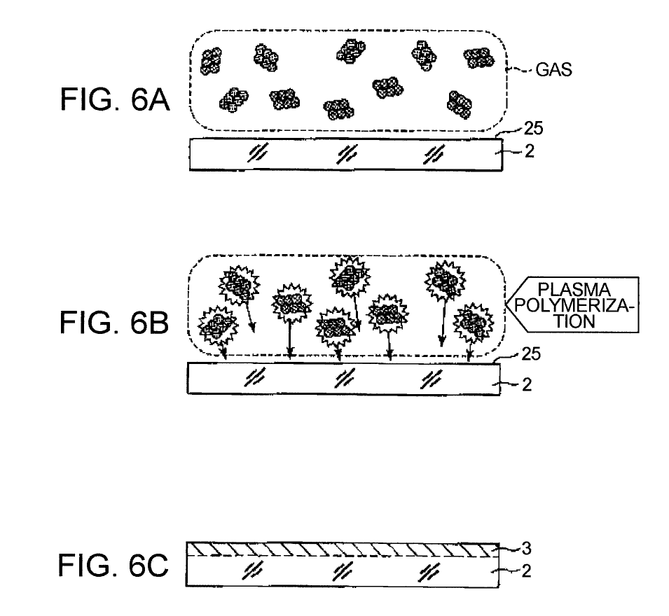

FIGS. 6A, 6B, and 6C are longitudinal sectional views explaining the method for forming the bonding film 3 on the first optical component 2. In the description below, upper and lower sides, respectively, in the drawings will be referred to as “top” and “bottom”, respectively.

In order to obtain the bonding film 3, the mixture gas of a raw gas and a carrier gas is supplied into a strong electric field to cause polymerization of molecules in the raw gas so as to allow a polymer obtained by the polymerization to be deposited on the first optical component 2. Details of the film formation will be described below.

First, the first optical component 2 is prepared. If desired, a surface treatment as mentioned above may be performed on a top surface 25 of the first optical component 2.

Next, the first optical component 2 is placed in the chamber 101 of the plasma polymerization apparatus 100 in a sealed condition. Then, with operation of the exhaustion pump 170, pressure inside the chamber 101 is reduced.

Next, the gas supplying section 190 is operated to supply the mixture gas of a raw gas and a carrier gas into the chamber 101. The supplied mixture gas fills the chamber 101 (See FIG. 6A).

In this case, a ratio of the raw gas included in the mixture gas (a mixture ratio) slightly varies depending on kinds of the raw gas and the carrier gas, an intended speed of film formation, and the like. The ratio of the raw gas in the mixture gas (a mixing ratio) varies more or less depending on kinds of the raw gas and the carrier gas, an intended film-formation speed, and the like. For example, the ratio of the raw gas in the mixture gas is set in a range preferably approximately from 20 to 70% and more preferably approximately from 30 to 60%. Thereby, a condition for formation of the polymerized film (film formation) can be optimized.

Next, the power supply circuit 180 is operated to apply a high frequency voltage between the pair of electrodes 130 and 140. Thereby, molecules of gas between the electrodes 130 and 140 are ionized, resulting in generation of plasma. Energy of the plasma generated causes polymerization of the molecules included in the raw gas, whereby a polymer of the raw gas is adhesively deposited on the first optical component 2, as shown in FIG. 6B. As a result, on the first optical component 2 is formed a plasma-polymerized film as the bonding film 3 (See FIG. 6C).

In addition, due to the effect of the plasma, the surface 25 of the first optical component 2 is activated and cleaned. This facilitates deposition of the polymer of the raw gas on the surface 25 of the first optical component 2, allowing stable formation of the bonding film 3. In this manner, the plasma polymerization, can further increase adhesive strength between the first optical component 2 and the bonding film 3, regardless of the material of the first optical component 2.

Examples of the raw gas include organosiloxanes such as methylsiloxane, octamethyltrisiloxane, decamethyltetrasiloxane, decamethylcyclopentasiloxane, octamethylcyclotetrasiloxane, and methylphenylsiloxane.

The plasma-polymerized film obtained using such a raw gas, namely, the bonding film 3, is made of the polymer obtained by polymerization of the raw material, namely, polyorganosiloxane.

In the plasma polymerization, the high frequency voltage applied between the pair of electrodes 130 and 140 is not restricted to a specific level, but ranges preferably approximately from 1 kHz to 100 MHz and more preferably approximately from 10 to 60 MHz.

A high frequency output density is not specifically restricted, but ranges preferably from 0.01 to 100 W/cm², more preferably from 0.1 to 50 W/cm², and still more preferably from 1 to 40 W/cm². Setting the high frequency output density in the above range, can ensure formation of the Si skeleton 301 having the random atomic structure, while preventing application of an excessive amount of plasma energy to the raw gas due to too high output density of the high frequency voltage. When the high frequency output density is below the lower limit value of the range, polymerization of the molecules in the raw gas cannot be caused, and thus, the bonding film 3 may not be formed. Conversely, a high frequency output density exceeding the upper limit value of the range causes decomposition of the raw gas or the like, for example. Then, a molecular structure that can be the leaving groups 303 is eliminated from the Si skeleton 301. This may result in reduction in content of the leaving groups 303 included in the bonding film 3 obtained, or reduction in the randomness of the Si skeleton 301 (namely an increase in regularity of the skeleton).

The pressure in the chamber 101 upon formation of the bonding film 3 ranges preferably approximately from 133.3×10⁻⁵ to 1333 Pa (1×10⁻⁵ to 10 Torr), and more preferably approximately from 133.3×10⁻⁴ to 133.3 Pa (1×10⁻⁴ to 1 Torr).

The flow rate of the raw gas ranges preferably approximately from 0.5 to 200 sccm, and more preferably approximately from 1 to 100 sccm. Meanwhile, the flow rate of the carrier gas ranges preferably approximately from 5 to 750 sccm, and more preferably approximately from 10 to 500 sccm.

The treatment time is preferably approximately 1 to 10 minutes, and more preferably approximately 4 to 7 minutes.

The temperature of the first optical component 2 is preferably equal to or higher than 25° C. and more preferably approximately 25 to 100° C.

In the conditions described above, the bonding film 3 can be obtained.

In the embodiment, upon the formation of the bonding film 3, by adjusting the film forming condition (including the output and the frequency of the high frequency, the flow rate and the kind of the raw gas, and the like) in the above range, the refractive index of the bonding film 3 obtained is adjusted in accordance with the refractive index of the optical components 2 and 4. Specifically, the bonding film 3 is formed by adjusting such that the refractive index of the bonding film 3 is approximately the same as that of the optical components 2 and 4.

In that case, as an adjusting method, for example, increasing the output of the high frequency allows the bonding film 3 to have a higher refractive index. Conversely, by reducing the output of the high frequency voltage, the bonding film 3 can have a lower refractive index. In short, there can be obtained a certain correlation between the output of the high frequency and the refractive index of the bonding film 3. Accordingly, using the correlation therebetween, the output of the high frequency voltage may be adjusted so as to allow the refractive index of the bonding film 3 to be set to an intended value. As for one reason why the adjusting method allows the adjustment of the refractive index of the bonding film 3, it seems that an amount of an organic component remaining in the plasma-polymerized film and a film density are changed in accordance with the output of the high frequency voltage and influence on the refractive index of the film. Among the film-formation conditions, particularly the output of the high frequency voltage is a parameter that can be adjusted easily and precisely, and thus, is a control factor suitable for precise adjustment of the refractive index.

In addition, the refractive index of the bonding film 3 can be adjusted also by appropriately adjusting film-formation conditions other than the output of the high frequency voltage such that plasma density upon the formation of the film is changed. Specifically, increasing the frequency of the high frequency voltage or the flow rate of the raw gas allows an increase in the plasma density upon formation of the film.

It is desirable that a difference between the refractive index of the bonding film 3 and the refractive index of the optical components 2 and 4 is made as small as possible. Preferably, the difference between these refractive indexes is less than 0.01. The small difference between the refractive indexes is optically almost negligible, thus ensuring suppression of diffusion of light on the bonded interface based on the refractive index difference. As a result, the multi-layered optical element 5 obtained can have excellent light transmission properties.

In addition, the obtained bonding film 3 having a refractive index ranging from 1.35 to 1.6 can be more precisely controlled. The refractive index of the bonding film 3 thus formed is close to that of quartz crystal or quartz glass. Accordingly, the bonding film 3 is suitably used to bond together optical components mainly made of quartz crystal or quartz glass.

Furthermore, the bonding film 3 has a thermal expansion rate close to that of quartz crystal and quartz glass, so that there is a small thermal expansion rate difference between the bonding film 3 and each optical component, thereby allowing suppression of post-bonding deformation in the multi-layered optical element 5.

### Second Embodiment

Next, a description will be given of a method for producing an optical element according to a second embodiment.

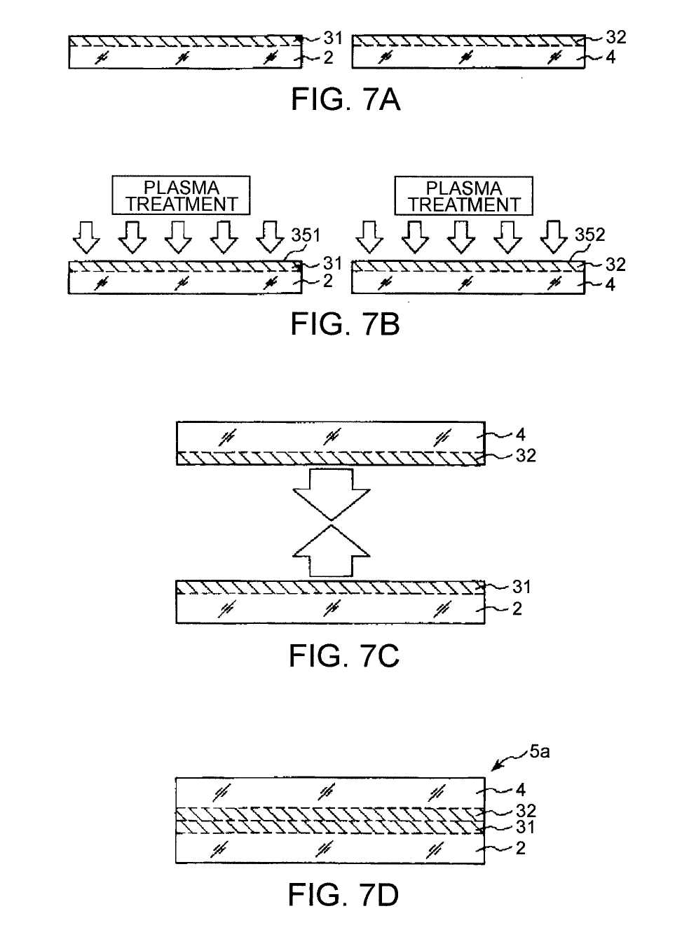

FIGS. 7A to 7D are longitudinal sectional views explaining the method for producing an optical element according to the second embodiment. In the description below, upper and lower sides, respectively, in FIGS. 7A to 7D, will be referred to as “top” and “bottom”, respectively.

Hereinafter, the description of the method of the second embodiment will focus on points that are different from the first embodiment, whereas descriptions of the same points as in the first embodiment will be omitted.

The method of the second embodiment is the same as the method of the first embodiment except that a bonding film is formed on a surface of each of the optical components 2 and 4 to bond the components 2 and 4 together such that the bonding films are closely adhered to each other.

Specifically, the method for producing an optical element according to the second embodiment includes preparing the first optical component 2 and the second optical component 4 to form a bonding film 31 on a surface of the first optical component 2 and a bonding film 32 on a surface of the second optical component 4, respectively, by plasma polymerization; applying energy to each of the bonding films 31 and 32; and bonding the first and the second optical components 2 and 4 together such that the bonding films 31 and 32 are closely adhered to each other so as to obtain a multi-layered optical element 5a. Hereinafter, the steps of the method of the second embodiment will be sequentially described.

1. First, as in the first embodiment, the first and the second optical components 2 and 4 are prepared. Then, the bonding films 31 and 32, respectively, are formed on the surfaces of the first and the second optical components 2 and 4, respectively, by plasma polymerization (See FIG. 7A). The bonding films 31 and 32 are preferably formed in the same film-forming conditions.

2. Next, as shown in FIG. 7B, energy is applied to each of the bonding films 31 and 32.

By the applying energy, the leaving groups 303 are eliminated from the Si skeleton 301 at the surface of each of the bonding films 31 and 32. An active bond occurs at a portion where the leaving groups 303 are eliminated, whereby the bonding film obtains stable adhesive properties to the second optical component 4. As a result, the bonding film 3 can be stably and strongly bonded to the second optical component 4 based on the chemical bonding.

3. Next, as shown in FIG. 7C, the first and the second optical components 2 and 4 are bonded together such that the bonding films 31 and 32 each having the adhesive properties are closely adhered to each other, thereby obtaining the multi-layered optical element 5a, as shown in FIG. 7D.

At the present step, the bonding films 31 and 32 are bonded together. The bonding between the films seems to be based on at least one of following two mechanisms I and II:

I. In one example case, an OH group is exposed on each of respective surfaces 351 and 352 of the respective bonding films 31 and 32. At the present step, when the first optical component 2 is bonded to the second optical component 4 such that the bonding films 31 and 32 are closely adhered to each other, the OH groups at the surfaces 351 and 352 of the bonding films 31 and 32 pull against each other by hydrogen bonding, thereby causing an attractive force between the OH groups. The attractive force seems to serve to bond together the first and the second optical components 2 and 4.

The OH groups pulling against each other by the hydrogen bonding are dehydrated and condensed depending on a temperature condition or the like. As a result, between the bonding films 31 and 32, respective bonds bonded to the OH groups are bonded to each other via an oxygen atom. Thereby, the first and the second optical components 2 and 4 seem to be more strongly bonded together.

II. When the first and the second optical components 2 and 4 are bonded together such that the bonding films 31 and 32 are closely adhered to each other, respective non-terminated bonds (dangling bonds) occurring at the surfaces 351 and 352 of the bonding films 31 and 32 and inside the films are re-bonded to each other. The rebinding occurs in such a complicated manner that the bonds are overlapped with each other (entangled with each other), thereby forming a network binding on a bonded interface between the films. As a result, base materials (the Si skeletons 301) of the bonding films 31 and 32 are directly bonded to each other, so that the bonding films 31 and 32 are integrated with each other.

Consequently, at least one of the above mechanisms I and II provides the multi-layered optical element 5a as shown in FIG. 7D.

In the multi-layered optical element 5a thus obtained, refractive indexes of the bonding films 31 and 32 are approximately the same as that of the first and the second optical components 2 and 4. In other words, when forming the bonding films 31 and 32, the refractive indexes of the films are adjusted so as to be approximately the same as that of the optical components 2 and 4 by adjusting film-forming conditions as desired. Accordingly, the multi-layered optical element 5 has the same effects and advantages as those of the multi-layered optical element 5 described in the first embodiment.

In the present embodiment, the two layers as the bonding films 31 and 32 are provided between the first and the second optical components 2 and 4. However, alternatively, three or more layers as bonding films may be provided therebetween.

The method for producing an optical element according to each of the embodiments above can be used to bond together various kinds of components.

For example, such components to be bonded together may be optical elements such as optical lenses, diffraction gratings, optical filters, and protection plates; photoelectric conversion elements such as solar cells; optical storage media such as optical discs; and display elements such as liquid crystal display elements, organic EL elements, and electrophoretic display elements.

### Optical Element

A description will be given of an example of the optical element of the embodiment applied to a wavelength plate.

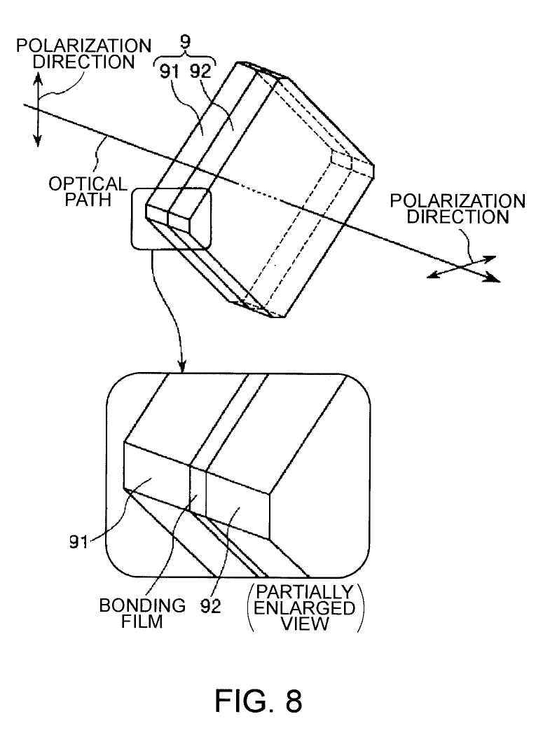

FIG. 8 is a perspective view of the wavelength plate obtained by applying the optical element of the embodiment.

A wavelength plate 9 shown in FIG. 8 is “a one-half wavelength plate” providing a phase difference of a one-half wavelength to transmitted light. The wavelength plate 9 includes two birefringent crystal plates 91 and 92 bonded together in such a manner that optic axes of the two plates are orthogonal to each other. Examples of birefringent materials include inorganic materials such as quartz crystal, calcite, MgF₂, YVO₄, TiO₂, and LiNbO₃ and organic materials such as polycarbonate.

When light is transmitted through the wavelength plate 9 thus structured, the light is split into a polarized component parallel to the optic axes and a polarized component vertical thereto. A phase delay of one of the components of the split light is induced due to a refractive index difference caused by birefringence of the crystal plates 91 and 92, thereby causing the phase difference mentioned above.

Precision of the phase difference provided to transmitted light by the wavelength plate 9 and transmittance of the wavelength plate 9 depend on precision of a plate thickness of each of the crystal plates 91 and 92. Thus, high-precision control is required for the thicknesses of the crystal plates 91 and 92.

In addition to that, a space between the crystal plates 91 and 92 has influence on the phase of transmitted light. Thus, a distance of the space between the crystal plates 91 and 92 needs to be precisely controlled, and the crystal plates 91 and 92 need to be strongly bonded together so as to inhibit any changes in the distance therebetween.

Thus, in the present embodiment, the optical element of the embodiment is applied to the wavelength plate 9, whereby the wavelength plate 9 can be easily obtained that includes the crystal plates 91 and 92 strongly bonded together via a bonding film.

Additionally, the bonding film in the optical element of the embodiment can be obtained by forming a film on a wide region at one time by plasma polymerization, namely, a gas phase film formation method. Thus, the film can be formed evenly on the wide region and high-precision control can be achieved for film thickness. This can keep a high parallelism between the crystal plates 91 and 92, thereby obtaining the wavelength plate 9 where aberrations such as wave-surface aberration are small.

Furthermore, the bonding film 3 has approximately the same refractive index as that of the crystal plates 91 and 92. This allows suppression of light diffusion due to refractive index difference on a bonded interface between the crystal plates 91 and 92, thus increasing light transmittance of the wavelength plate 9.

Still furthermore, the wavelength plate 9 may be a one-quarter wavelength plate, a one-eighth wavelength plate, or the like, instead of being the one-half wavelength plate.

In addition, as examples of the optical element of the embodiment, besides such a wavelength plate, there may be mentioned optical filters such as polarization filters, compound lenses such as optical pick-ups, prisms, diffraction gratings, and the like.

Hereinabove, the optical element of the embodiment and the method for producing an optical element of each of the embodiments have been described with reference to the drawings. However, the invention is clearly not restricted to the embodiments described above.

For example, a method for producing an optical element according to another embodiment may be provided by combining with at least one arbitrarily selected from the methods of the above embodiments.

In addition, the method for producing an optical element according to each of the embodiments may further include at least one arbitrarily intended step, as desired.

Additionally, each of the embodiments above has described the method for bonding together the two optical components (the first and the second optical components 2 and 4). However, alternatively, the method of each of the embodiments may be used to bond together three or more optical components.

Furthermore, in the optical element of the each embodiment, the refractive index of the bonding film 3 is set to be approximately the same as that of both the first and the second optical components 2 and 4. However, the optical element of the embodiment is not restricted to that and may include the bonding film 3 whose refractive index is approximately the same as that of one of the optical components 2 and 4. Even in this case, light transmission properties on the bonded interface between the bonding film 3 and the one of the optical components can be increased, so that the multi-layered optical element 5 finally obtained can exhibit excellent light transmission properties.

In the each embodiment, the bonding film is formed on the entire part of the surface of the corresponding optical component, but may be formed only on a part of the surface thereof. In this case, adjusting the bonding region appropriately allows alleviation of stress concentration on the bonded interface, thereby preventing problems such as deformation of the optical components and separation of the bonded interface. Additionally, since a space is formed between the two optical components, gas such as air may be flown into the space so that the optical components can be forcefully cooled, for example.

Still furthermore, in the each embodiment, adhesive properties are generated by applying energy on the entire region of the surface of the each bonding film. However, adhesive properties may be generated on a partial region of the surface thereof. Also in this case, adjusting the bonding region appropriately can alleviate stress concentration on the bonded interface, thereby preventing the problems such as optical component deformation and bonded interface separation.

### EXAMPLES

Next, specific examples of the embodiments will be described.

1. Production of Multi-Layered Optical Element

Hereinafter, a description will be given of Examples (Exs) and a Comparative Example (Com-Ex), each of which produced a plurality of multi-layered optical elements.

### Example 1

First, each quartz crystal substrate was prepared for each of the first and the second optical components. The quartz crystal substrate for the first optical component had a length of 20 mm, a width of 20 mm, and a mean thickness of 2 mm, and the quartz crystal substrate for the second optical component 4 had a length of 20 mm, a width of 20 mm, and a mean thickness of 1 mm. The quartz crystal substrates were subjected to optical polishing. The quartz crystal substrates had a refractive index of 1.546 with respect to light having a wavelength of 546 nm.

Then, each of the substrates was placed in the chamber 101 of the plasma polymerization apparatus 100 shown in FIG. 5 to perform surface treatment using oxygen plasma.

Next, on a surface of each substrate subjected to the surface treatment was formed a plasma-polymerized film having a mean thickness of 150 nm. Conditions for formation of the film were as follows:

Conditions for Formation of Film

Composition of raw gas: octamethyltrisiloxane

Flow rate of raw gas: 10 sccm

Composition of carrier gas: Argon

Flow rate of carrier gas: 10 sccm

Output of high frequency power: 100 W

High frequency output density: 25 W/cm²

Pressure inside Chamber: 1 Pa (low vacuum)

Treatment time: 215 seconds

Substrate temperature: 20° C.

Under the above conditions, the plasma-polymerized film was formed on each of the substrates.

The each plasma-polymerized film thus formed was made of a polymer of octamethyltrisiloxane (raw gas). The plasma-polymerized film included an Si skeleton having a random atomic structure including a siloxane bond and an alkyl group (a leaving group). Additionally, the degree of crystallization of the plasma-polymerized film was measured by an infrared absorption method. As a result, the degree of crystallization of the plasma-polymerized film was equal to or less than 30%, although there were some variations depending on measured portions.

Next, plasma treatment was applied to the obtained plasma-polymerized films under following conditions.

Conditions for Plasma Treatment

Plasma treatment method: direct plasma method

Composition of treatment gas: helium gas

Pressure of atmosphere: atmospheric pressure (100 kPa)

Distance between electrodes: 1 mm

Voltage applied: 1 kVp-p

Voltage frequency: 40 MHz

Next, one minute after the plasma treatment, the substrates were placed on each other such that the plasma-polymerized films were contacted with each other, so as to obtain a multi-layered optical element.

After that, regarding the bonding film in the obtained multi-layered optical element, again, a refractive index with respect to the light having the wavelength of 546 nm was measured.

### Example 2

Each multi-layered optical element was obtained in the same manner as in Example 1 except that the high frequency power for forming the plasma-polymerized film was changed to 150 W.

### Example 3

Each multi-layered optical element was obtained in the same manner as in Example 1 except that the high frequency power for forming the plasma-polymerized film was changed to 200 W.

### Example 4

Each multi-layered optical element was obtained in the same manner as in Example 1 except that the high frequency power for forming the plasma-polymerized film was changed to 250 W.

### Example 5

Each multi-layered optical element was obtained in the same manner as in Example 1 except that the high frequency power for forming the plasma-polymerized film was changed to 300 W.

### Example 6

Each multi-layered optical element was obtained in the same manner as in Example 1 except that the high frequency power for forming the plasma-polymerized film was changed to 325 W.

### Example 7

Each multi-layered optical element was obtained in the same manner as in Example 1 except that the high frequency power for forming the plasma-polymerized film was changed to 350 W.

### Comparative Example

Each multi-layered optical element was obtained in the same manner as in Example 1 except that the first and the second optical components were bonded together with an epoxy optical adhesive (a mean thickness of 3 μm).

2. Evaluation of Multi-Layered Optical Element

2-1. Evaluation of Bonding Strength (Splitting Strength)

Bonding strength was measured for each multi-layered optical element obtained in the Examples and the Comparative Example.

Measurement of the bonding strength was performed by measuring strength immediately before separation between the substrates. In addition, the bonding strength was measured, immediately after bonding and after performing 100 times of temperature-cycle repetitions from −40 to 125° C. after the bonding, respectively.

As a result, the multi-layered optical elements obtained in the Examples had sufficient bonding strength in both of the measurement immediately after the bonding and the measurement after the temperature cycle repetitions.

Meanwhile, the multi-layered optical elements obtained in the Comparative Example had sufficient bonding strength immediately after the bonding, but showed reduction in the bonding strength after the temperature-cycle repetitions.

2-2. Evaluation of Size Precision

Size precision in a thickness direction (the degree of parallelism) was measured for the multi-layered optical elements obtained in the Examples and the Comparative Example.

Specifically, thicknesses of four corners of each multi-layered optical element were measured with a micro gauge. Then, based on a difference among the thicknesses of the four corners, a relative inclination between opposite surfaces of the multi-layered optical element was calculated.

As a result, the multi-layered optical elements obtained in the Examples had a parallelism of ±1 seconds or less and also showed a small variation in parallelism among the multi-layered optical elements.

In contrast, the multi-layered optical elements obtained in the Comparative Example had a parallelism of ±1 seconds or more and also showed a large variation in parallelism among the multi-layered optical elements.

2-3. Evaluation of Refractive Index

Among bonding films obtained in the Examples, refractive indexes were compared. The comparison results showed that the refractive indexes were gradually increased as the output of the high frequency power was gradually increased when forming the plasma-polymerized films. Specifically, it was shown that the output of the high frequency power was in proportion to the refractive index. This indicated that adjustment of the film-forming conditions of the plasma-polymerized film allows adjustment of the refractive index of the bonding film.

In addition, the bonding film included in the multi-layered optical elements in Example 6 had the refractive index approximately the same as that of the quartz crystal substrates.

2-4. Evaluation of Light Transmittance

Light transmittance in a thickness direction was measured regarding the multi-layered optical elements obtained in the Examples and the Comparative Example. Measurements of the light transmittance were performed after applying a light beam having the wavelength of 546 nm at an output of 100 mW continuously for 1000 hours in an environment of 70° C. Then, light transmittances measured were evaluated based on evaluation criteria below.

Evaluation Criteria of Light Transmittance

Excellent: Light transmittance was 99.8% or higher.

Good: Light transmittance was 99.0% or higher and lower than 99.8%.

Fairly good: Light transmittance was 98.0% or higher and lower than 99.0%.

Poor: Light transmittance was lower than 98.0%.

Table 1 shows the evaluation results of the light transmittances.

TABLE 1

| | Conditions for production of | | | | | |
|---|---|---|---|---|---|---|
| | multi-layered optical element | | | Evaluation results | | |
| | Type of | Mean | High frequency | Refractive index | Light | Appearance |
| | Bonding | thickness of | output upon film | after bonding | transmittance | (Light |
| | film | bonding film | formation (W) | (λ: 546 nm) | (λ: 546 nm) | resistance) |
| Ex. 1 | Plasma- | 150 + 150 nm | 100 | 1.461 | Good | Excellent |
| Ex. 2 | polymerized | 150 + 150 nm | 150 | 1.480 | Good | Excellent |
| Ex. 3 | film | 150 + 150 nm | 200 | 1.500 | Good | Excellent |
| Ex. 4 | | 150 + 150 nm | 250 | 1.520 | Good | Excellent |
| Ex. 5 | | 150 + 150 nm | 300 | 1.534 | Good | Excellent |
| Ex. 6 | | 150 + 150 nm | 325 | 1.547 | Excellent | Excellent |
| Ex. 7 | | 150 + 150 nm | 350 | 1.560 | Good | Excellent |
| Com-Ex | Epoxy | 3 μm | — | 1.550 | Poor | Poor |
| | adhesive | | | | | |

As clear from Table 1, the multi-layered optical elements obtained in the Examples had light transmittances of 99% or higher and thus exhibited excellent light transmission properties. Meanwhile, the multi-layered optical elements obtained in the Comparative Example had sufficient light transmission properties immediately after a start of transmission of light, but exhibited light transmittances lower than 98% after the elapse of 1000 hours, thus showing reduction in the light transmission properties.

2-5 Evaluation of Appearance

Light having the wavelength of 404 nm and the output power of 100 mW was applied to the multi-layered optical elements obtained in the Examples and the Comparative Example, continuously for 1000 hours in the atmosphere of 70° C. Then, appearances of portions subjected to application of the light were evaluated based on following evaluation criteria.

Evaluation Criteria for Appearance

Excellent: no color change or no air bubble was found on a bonded interface.

Good: color changes or air bubbles were slightly found in a dotted pattern on the bonded interface.

Fairly good: many color changes or air bubbles were found in a dotted pattern on the bonded interface.

Poor: many color changes or air bubbles were found in a layered pattern on the bonded interface.

Table 1 shows evaluation results of the appearances.

As clear from Table 1, no color changes or no air bubbles were observed on the bonded interface in each of the multi-layered optical elements obtained in the Examples, whereas, in the multi-layered optical elements obtained in the Comparative Example, there were observed color changes in an optical path portion.

What is claimed is:

1. A method for producing an optical element, comprising:
preparing a first optical component and a second optical component each having light transmission properties;
forming a bonding film on a surface of the first optical component by plasma polymerization, the bonding film including an Si skeleton having a random atomic structure including a siloxane (Si—O) bond and leaving groups binding to the Si skeleton;
applying energy to the bonding film to eliminate the leaving groups from the Si skeleton at a surface of the bonding film so as to provide adhesive properties; and
bonding together the first and the second optical components via the bonding film to obtain the optical element,
the bonding film having a refractive index adjusted to be approximately the same as a refractive index of at least one of the first and the second optical components by adjusting a film forming condition of the plasma polymerization.

2. The method according to claim 1, wherein, in all atoms except for H atoms included in the bonding film, a sum of Si atoms and O atoms ranges from 10 to 90 atom percent.

3. The method according to claim 1, wherein a ratio of the Si atoms and the O atoms in the bonding film ranges from 3:7 to 7:3.

4. The method according to claim 1, wherein a degree of crystallization of the Si skeleton is equal to or less than 45 percent.

5. The method according to claim 1, wherein the bonding film includes an Si—H bond.

6. The method according to claim 5, wherein when a peak intensity of the siloxane bond is set to 1 in an infrared absorption spectrum of the bonding film including the Si—H bond, a peak intensity of the Si—H bond ranges from 0.001 to 0.2.

7. The method according to claim 1, wherein the leaving groups include at least one of an H atom, a B atom, a C atom, an N atom, an O atom, a P atom, an S atom, a halogen atom, and an atom group in which each of the atoms is arranged so as to bind to the Si skeleton.

8. The method according to claim 7, wherein the leaving groups are alkyl groups.

9. The method according to claim 8, wherein when a peak intensity of the siloxane bond is set to 1 in the infrared absorption spectrum of the bonding film including methyl groups as the leaving groups, a peak intensity of the methyl group ranges from 0.05 to 0.45.

10. The method according to claim 1, wherein the bonding film includes an active bond at a portion where the leaving groups at the surface of the bonding film are eliminated from the Si skeleton.

11. The method according to claim 10, wherein the active bond is a dangling bond or a hydroxyl group.

12. The method according to claim 1, wherein the bonding film is mainly made of polyorganosiloxane.

13. The method according to claim 12, wherein the polyorganosiloxane predominantly contains a polymer of octamethyltrisiloxane.

14. The method according to claim 1, wherein, in the plasma polymerization, a high frequency output density for generating plasma is adjusted in a range from 0.01 to 100 W/cm².

15. The method according to claim 1, wherein a mean thickness of the bonding film ranges from 1 to 1,000 nm.

16. The method according to claim 1, wherein the bonding film is a solid having no fluidity.

17. The method according to claim 1, wherein the refractive index of the bonding film is adjusted to a predetermined value ranging from 1.35 to 1.6.

18. The method according to claim 1, wherein the energy application includes at least one of application of an energy ray to the bonding film and exposure of the bonding film to plasma.

19. The method according to claim 18, wherein the energy ray is ultraviolet light having a wavelength ranging from 126 to 300 nm.

20. The method according to claim 18, wherein the plasma to which the bonding film is exposed is atmospheric pressure plasma.

21. The method according to claim 1, wherein the first and the second optical components are made of quartz glass or quartz crystal.

22. The method according to claim 1, wherein the bonding film is formed such that a difference between the refractive index of the bonding film and the refractive index of the at least one of the first and the second optical components is less than 0.01.

23. The method according to claim 1, wherein the film forming condition is a high frequency output.

24. The method according to claim 1, wherein the bonding film includes at least two bonding film layers formed between the first and second optical components.

25. An optical element, comprising:
a first optical component and a second optical component each having light transmission properties; and
a bonding film bonding the first and the second optical components together, the bonding film being plasma polymerized and including an Si skeleton having a random atomic structure including a siloxane (Si—O) bond and leaving groups binding to the Si skeleton,
the first and the second optical components being bonded together by the bonding film having adhesive properties provided by eliminated leaving groups from the Si skeleton at a surface of the bonding film; and
the bonding film having approximately the same refractive index as a refractive index of at least one of the first and the second optical components by adjusting a film forming condition in the plasma polymerization.
